(19) United States
(12) Patent Application Publication
(10) Pub. No.: US 2026/0002037 A1
(43) Pub. Date: Jan. 1, 2026

(54) SOLVENT RESISTANT INKS

(71) Applicant: VIDEOJET TECHNOLOGIES INC., Wood Dale, IL (US)

(72) Inventors: Wei Weng, Naperville, IL (US); Fengfei Xiao, Glenview, IL (US); Godwin Deng, Schaumburg, IL (US); Linfang Zhu, Woodridge, IL (US)

(73) Assignee: VIDEOJET TECHNOLOGIES INC., Wood Dale, IL (US)

(21) Appl. No.: 19/320,331

(22) Filed: Sep. 5, 2025

Related U.S. Application Data
(63) Continuation of application No. PCT/US2024/018564, filed on Mar. 5, 2024.
(60) Provisional application No. 63/488,678, filed on Mar. 6, 2023.

(51) Int. Cl. C09D 11/328

(52) U.S. Cl. CPC C09D 11/328

(57) ABSTRACT

Described herein are ink jet ink compositions for continuous inkjet printing comprising a solvent, a cosolvent, a binder resin, and a colorant. Such ink jet ink compositions are resistant to organic solvents, such as alcohols, and are intended for use in industries where such solvents are commonly used, such as electronics, cosmetics, healthcare, and pharmaceuticals.

### CROSS REFERENCE TO RELATED APPLICATIONS

This application is a continuation of PCT Application No. PCT/US2024/018564, filed Mar. 5, 2024, which claims the benefit of priority to U.S. Provisional Patent Application No. 63/488,678 filed Mar. 6, 2023, which is incorporated herein by reference, in its entirety for any and all purposes.

### FIELD

This application is directed to an ink composition for continuous inkjet printing, the ink composition comprising a solvent, a cosolvent, a binder resin, and a colorant. The ink composition provides markings that are resistant to organic solvents, such as alcohols, and is intended for use in industries where such solvents are commonly used, such as electronics, cosmetics, healthcare, and pharmaceuticals.

### BACKGROUND

In ink jet printing, printing is accomplished without contact between the printing device and the substrate on which the printed characters are deposited. Briefly described, inkjet printing involves projecting a stream of ink droplets to a surface and controlling the direction of the stream, e.g., electronically, so that the droplets are caused to form the desired printed image on that surface. This technique of noncontact printing is well suited for application of characters onto a variety of surfaces including porous and non-porous surfaces.

In general, an inkjet ink composition should meet certain requirements to be useful in inkjet printing operations. These relate to viscosity, resistivity, solubility, compatibility of components, and wettability of the substrate. Further, the ink should be quick-drying and smear-resistant, should be capable of passing through the inkjet nozzle without clogging, and should permit rapid cleanup of the machine components with minimum effort. In addition, the jet ink composition should provide printed images that adhere well to the substrates, particularly non-porous substrates, which, as is known to those of ordinary skill in the art pose challenges with respect to achieving image adhesion.

Most continuous inkjet (CIJ) inks use methyl ethyl ketone (MEK) as the solvent or the main solvent because such inks produce a fast dry time due to their volatility, good adhesion, and because MEK is a good solvent for the binder resins and dyes in the inks. However, it would be desirable to develop inks that do not use MEK, due to concerns relating to health and safety and associated regulations.

In certain applications, such as in electronics, cosmetics, healthcare, and pharmaceuticals, there are further challenges as inks are additionally required to have resistance to particular solvents, principally alcohols such as ethanol, n-propanol, and iso-propanol. Many products in these industries contain alcohols, or are cleaned using alcohol-based cleaners, and thus there is a need for printed marks that are resistant to alcohol in the event of spill, overfill, or subsequent cleaning.

WO 2018/191468 A1, hereby incorporated by reference in its entirety, describes fast drying ink compositions that avoid the use of MEK and provide markings that are highly adherent to a range of substrates (both porous and non-porous) and fare well when subjected to physical challenge. However, these inks are suboptimal when it comes to solvent resistance.

The solvent resistivity of a marking formed from an ink depends on both the binder resin and the solvent used in the ink formulation, with different combinations of binder resin and solvent producing dried films with different microstructures. These different microstructures arise from the differing drying behaviour of the inks, for example, after initial rapid loss of solvent, resin aggregates may form on the liquid-air interface and orient in a particular way, leading to increasingly non-uniform evaporation as time goes on. These different microstructures can enhance or detract from the solvent resistance of the ink by influencing the penetration rate of the solvent (e.g. alcohol) into the film.

### SUMMARY OF THE INVENTION

A first aspect of the present invention relates to an ink composition, the ink composition comprising (a) a solvent comprising one or more volatile C₅ ketones, the one or more volatile C₅ ketones present in an amount from about 30% to about 80% by weight of the ink composition; (b) a cosolvent selected from ethanol, n-propanol, isopropanol, isopropyl acetate, n-propyl acetate, ethyl acetate, cyclopentanone, cyclohexanone and mixtures thereof, the cosolvent present in an amount from about 3% to about 45% by weight of the ink composition; (c) one or more binder resins selected from copolymers of vinyl chloride and vinyl acetate, polyesters, co-polyesters, and mixtures thereof, the total binder resin present in an amount from about 2% to about 20% by weight of the ink composition; and (d) one or more colorants. The ink composition has excellent solvent resistance. The ink composition is particularly suitable as a continuous inkjet ink composition.

In embodiments, the one or more volatile C₅ ketones is selected from the group consisting of 2-pentanone (methyl propyl ketone), 3-pentanone (diethyl ketone), 3-methyl-2-butanone (methyl isopropyl ketone), and mixtures thereof. Preferably, the solvent is methyl propyl ketone.

In embodiments, the cosolvent is selected from ethanol, cyclopentanone, cyclohexanone, a mixture of ethanol and ethyl acetate, a mixture of ethanol and cyclopentanone, a mixture of ethanol and cyclohexanone, and a mixture of isopropyl acetate and cyclohexanone.

In embodiments, the one or more volatile ketones is present in an amount from about 65% to about 80% by weight of the ink composition.

In embodiments, the cosolvent is present in an amount from about 5% to about 20% by weight of the ink composition, optionally from about 10% to about 18% by weight of the ink composition.

In embodiments, the one or more binder resins are copolymers of vinyl chloride and vinyl acetate. Alternatively, the one or more binder resins are a mixture of copolymers of vinyl chloride and vinyl acetate and polyester. The binder resins may be present in an amount from about 7% to about 16% by weight of the ink composition.

In certain embodiments according to the invention, the one or more colorants are selected from the group consisting of Solvent Black 29, Solvent Black 27, and mixtures thereof, and preferably the one or more colorant is Solvent Black 27.

Other embodiments according to the invention include ink compositions which further comprise one or more additives selected from the group consisting of a surfactant, a plasticizer, an adhesion promoter, a corrosion inhibitor, a conductive agent, a defoamer, and mixtures thereof. Surfactants preferably are polyalkyleneoxide modified polysiloxanes. Preferably, if present, the one or more surfactants are present in an amount from about 0.1% to about 2.0% by weight of the ink composition. Preferably, if present, the corrosion inhibitor is present in an amount from about 0.01% to 0.2% by weight of the ink composition.

In embodiments, the one or more volatile C5 ketone solvent is methyl propyl ketone, the cosolvent is ethanol, and the one or more binder resins are copolymers of vinyl chloride and vinyl acetate. In particular embodiments, the methyl propyl ketone is present in an amount of about 70% by weight of the ink composition, the ethanol is present in an amount of about 15% by weight of the ink composition, and the copolymers of vinyl chloride and vinyl acetate are present in an amount of about 9% by weight of the ink composition.

A second aspect of the present invention relates to a method of continuous inkjet printing on a substrate comprising: directing a stream of droplets of an ink composition according to the first aspect of the present invention onto the substrate and allowing the droplets to dry, to print an image on the substrate. The substrate can be porous, semi-porous, or non-porous, such as substrates selected from the group consisting of uncoated paper, coated paper, hard or soft plastics, polymer films, metals and alloys, glass, and ceramics.

### DETAILED DESCRIPTION

### Definitions

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise defined, all technical and scientific terms used herein are intended to have the same meaning as commonly understood in the art to which this invention pertains at the time of its filing. Although various methods and materials similar or equivalent to those described herein can be used in the practice or testing of the present invention, suitable methods and materials are described below. However, the skilled should understand that the methods and materials used and described are examples and may not be the only ones suitable for use in the invention.

Moreover, it should also be understood that as measurements are subject to inherent variability, any temperature, weight, volume, time interval, pH, salinity, molarity or molality, range, concentration and any other measurements, quantities or numerical expressions given herein are intended to be approximate and not exact or critical figures unless expressly stated to the contrary. Hence, where appropriate to the invention and as understood by those of skill in the art, it is proper to describe the various aspects of the invention using approximate or relative terms and terms of degree commonly employed in patent applications, such as: about, approximately, substantially, essentially, consisting essentially of, comprising, and effective amount. Unless defined otherwise, all technical and scientific terms used herein have the same meaning as commonly understood by one of ordinary skill in the art.

The terms “inkjet” or “ink jet,” as used herein, refer to inkjet printing, a type of printing that creates an image by propelling small droplets of ink onto a substrate such as paper, plastic, metal, glass, and the like. “Continuous inkjet” or “CIJ” methods are used, for example, in the marking and coding of products and packages. In this method, a pump directs a liquid ink composition from a reservoir to a nozzle to create a continuous stream of ink droplets, which are subjected to a controlled and variable electrostatic field, and thereby are charged as the droplets form according to the varying electrostatic field. The charged droplets are deflected to the proper location by passing through another electrostatic field to print the desired pattern on a substrate, or are recycled back to the reservoir for future use.

The phrases “substantially free of” or “substantially no,” as used herein, in the context of a solvent or other component in the inventive ink composition, refers to a condition in which preferably no appreciable or readily detectable amount of the indicated component is present in the composition. “Substantially no” or “substantially free of” can refer to an amount which is below the detection limit of commonly used detection methods known in the art, or below the maximum amount permitted for the compound by regulation, or an amount below 5%, and preferably below 2%, below 1%, or below 0.5%.

The term “about,” as used herein, means plus or minus 10 percent of the recited value, so that, for example, “about 0.125” means 0.125±0.0125, and “about 1.0” means 1.0±0.1.

The terms “solvent” and “cosolvent”, as used herein, refer to components whose primary function is to dissolve and carry the other components of the ink composition.

The term “colorant,” as used herein, refers to a dye, pigment or other substance that imparts color or modifies the hue of something else, and can refer to any such substance. Colorants include black dyes as well as other colors.

The term “volatile,” as used herein refers to the tendency of a substance to vaporize, related to the vapor pressure of the substance. A volatile solvent is one that has the capability of evaporating or going into a vapor phase.

The term “additive,” as used herein, refers to an optional component that may be added to the inventive ink composition.

The term “binder resin,” as used herein, refers to a substance that aids in making the ink composition stick to the substrate to which it is applied during printing. In general, a binder is a material that holds other materials together to form a cohesive whole or to impart adhesive properties. References to Mn (or number average molecular weight) or to Mw (or weight average molecular weight) refer to values measured by GPC (or SEC) against polystyrene standards using THE as the eluent, as is described in ISO 13885-1:2020.

Unless indicated otherwise, percentages (%) of components of the ink composition are percentages of the total weight of the ink composition. Similarly, unless indicated otherwise, ratios are to be interpreted as mass ratios.

It will be understood that references to the ink having a resistance to solvents is in reference to the markings produced when the ink is printed onto a surface having the resistance to solvents.

### Overview

The ink compositions described herein employ one or more volatile C5 ketone solvents, a cosolvent, a binder resin, and a colorant. The ink compositions also optionally contain other additives such as a plasticizer, a surfactant, a conductive agent, additional solvents, an adhesion promoter, and/or a defoamer.

### Embodiments of the Invention

The ink composition of the invention may have any suitable viscosity or surface tension. In embodiments of the invention, the ink composition has a viscosity in the range of 1 cP to 10 cP, preferably in the range of 2 cP to 6 cP at 25° C. The ink composition preferably has a viscosity of less than about 10 cP, preferably less than about 6 cPs at 25° C. Viscosity may be determined using a viscometer, such as a Brookfield Digital Viscometer (for example: LTDV-I, DV-I+, DVI Digital or equivalent) with the low viscosity UL adapter assembly, using a method as described in ISO 2555:2018 modified to use an ultra-low viscosity adapter.

The ink compositions of the invention preferably has a surface tension from about 20 to about 30 mN/m at 25° C.

The ink compositions of the invention preferably have a resistivity at 25° C. of about 500-2000 Ohm-cm or preferably about 900-1500 Ohm-cm. Resistivity may be determined using a resistivity meter, such as an A212 Orion Star from Fisher Scientific, YSI Model 3200 Conductance/Resistance Meter, using a method as described in ASTM D1169-19A.

The inkjet ink compositions according to embodiments of the invention preferably are stable at least over a period of several weeks (e.g. 4-6 weeks) at temperature extremes, such as between −15° C. and 60° C.

The inkjet ink compositions include one or more volatile C5 ketone solvents. Suitable volatile C5 ketone solvents include 2-pentanone (methyl propyl ketone, or MPK), 3-methyl-2-butanone (methyl isopropyl ketone, or MIPK), and 3-pentanone (diethyl ketone, or DEK). Preferably the one or more volatile C5 ketone comprises methyl propyl ketone. Alternatively, the one or more volatile C5 ketone consists of, or consists essentially of, methyl propyl ketone.

The one or more volatile C5 ketone solvents may be present in an amount between about 50% and about 90% by weight of the ink composition. Preferably, the one or more volatile C5 ketone solvents is present in an amount between about 60% and about 80% by weight of the ink composition, more preferably in an amount between about 65% and about 75% by weight of the ink composition, most preferably in an amount of about 70% by weight of the ink composition. Alternatively, the one or more volatile C5 ketone solvents may be present in an amount between about 30% and about 50% by weight of the ink composition, preferably in an amount between about 35% and about 45% by weight of the ink composition, more preferably in an amount of about 40% by weight of the ink composition.

The inkjet ink compositions include a cosolvent selected from ethanol, n-propanol, isopropanol, isopropyl acetate, n-propyl acetate, ethyl acetate, cyclopentanone, cyclohexanone and mixtures thereof, the cosolvent present in an amount from about 3% to about 25% by weight of the ink composition. The cosolvent may be selected from ethanol, cyclopentanone, cyclohexanone, a mixture of ethanol and ethyl acetate, a mixture of ethanol and cyclopentanone, a mixture of ethanol and cyclohexanone, and a mixture of isopropyl acetate and cyclohexanone. The cosolvent may be present in an amount from about 5% to about 20% by weight of the ink composition, optionally from about 10% to about 18% by weight of the ink composition. Alternatively, the cosolvent may be present in an amount from about 35% to about 55% by weight of the ink composition, optionally from about 40% to about 50% by weight of the ink composition.

In embodiments, the cosolvent comprises ethanol. The ethanol may be present in an amount of between about 10% and about 20% by weight of the ink composition, preferably in an amount of about 15% by weight of the ink composition. In some embodiments, the ethanol cosolvent further includes cyclopentanone, preferably in an amount of about 5% by weight of the ink composition. In some embodiments, the ethanol cosolvent further includes cyclohexanone, preferably in an amount of about 5% by weight of the ink composition.

In embodiments, the cosolvent comprises isopropyl acetate. The isopropyl acetate may be present in an amount from about 5% and about 20% by weight of the ink composition, preferably in an amount of about 15% by weight of the ink composition. In some embodiments, the cosolvent further includes cyclopentanone, preferably in an amount from about 5% to about 10% by weight of the ink composition.

In embodiments, the cosolvent comprises n-propanol. The n-propanol may be present in an amount from about 5% to about 20% by weight of the ink composition, preferably in an amount of about 10% by weight of the ink composition.

In embodiments, the cosolvent comprises cyclohexanone. The cyclohexanone may be present in an amount from about 2% to about 10% by weight of the ink composition, preferably in an amount of about 5% by weight of the ink composition.

In embodiments, the cosolvent comprises cyclopentanone. The cyclopentanone may be present in an amount from about 2% to about 10% by weight of the ink composition, preferably in an amount of about 8% by weight of the ink composition.

In embodiments, the cosolvent comprises ethyl acetate. The ethyl acetate may be present in an amount from about 25% to about 50% by weight of the ink composition, preferably in an amount from about 30% to about 45% by weight of the ink composition.

In embodiments, the solvents of the ink composition comprise the volatile C5 ketone solvent and cosolvent. In other embodiments, the solvents of the ink composition consist of, or consist essentially of, the volatile C5 ketone solvent and cosolvent (i.e. further solvents are excluded, or excluded to the extent that they alter the character of the ink). For example, the solvent may be free of, or substantially free of, one or more of methyl ethyl ketone, acetone, saturated alkanes, cyclic or non-cyclic aliphatic hydrocarbons (such as hexane), aromatic hydrocarbons (such as toluene), carbonates (such as propylene carbonate, ethylene carbonate, dimethyl carbonate, and diethyl carbonate), chlorinated solvents (such as dichloromethane and chloroform), diemthylformamide, N-methylpyrrolidone, dioxanes, and cyclic and non-cyclic acetals.

The preferred ink composition embodiments of the invention include at least one binder resin, however more than one binder resins can be present. The amount of the binder resin in the compositions can be determined by the skilled artisan, and depends on the binder resin or binder resins chosen. The total amount of binder resin can be any suitable amount. For example, the binder resin or combination of binder resins can be present in an amount from about 0.1% to about 30%, preferably from about 2% to about 20%, and more preferably from about 4% to about 18% of the inkjet ink composition. The most preferred compositions contain about 7% to about 16% binder resin(s). Preferably the at least one binder resin is insoluble in ethanol (e.g. having a solubility of less than 1% at a temperature of 25° C.). Preferably the at least one binder resin has a hydroxyl number less than 50, more preferably less than 10; and acid numbers less than 15, more preferably less than 10.

One preferred class of binder resins are copolymers of vinyl chloride and vinyl acetate, optionally containing minor quantities of further monomers, such as dicarboxylic acid. Commercial examples of such resins include VINNOL®, available from Wacker Chemie® AG, and SOLBIN® CLL, available from Shin-Estu Chemical Co. Ltd. The copolymers may comprise from about 70% to about 95% by weight vinyl chloride and from about 5% to about 30% by weight vinyl acetate, preferably from about 80% to about 90% by weight vinyl chloride and from 10% to about 20% by weight vinyl acetate, and most preferably about 85% by weight vinyl chloride and about 15% by weight vinyl acetate. The copolymer may have a Mw in the range of from about 30000 to about 60000 g/mol, such as from 30000 to 40000 g/mol or from, 50000 to 60000 g/mol. The copolymer may have a K-value in the range of from about 34 to about 46, such as from 34 to 36 or from 44 to 46. In embodiments, a single copolymer of vinyl chloride and vinyl acetate may be used. Alternatively, a mixture of copolymers of vinyl chloride and vinyl acetate may be used. In embodiments wherein the one or more binder resins comprise one or more copolymers of vinyl chloride and vinyl acetate, the copolymers may be present in an amount of from about 5% to about 15% by weight of the ink composition, preferably in an amount of from about 6% to about 10% by weight of the ink composition, more preferably in an amount of from about 7% to about 9% by weight of the ink composition, most preferably about 8% by weight of the ink composition.

Another preferred class of binder resins are polyesters and co-polyesters. It will be understood that polyesters typically comprise polyol and polyacid monomers, and may be branched or linear. Linear polyesters typically make use of diols and diacids in a 1:1 molar ratio, whereas branched polyesters further include higher functionality polyols and diacids to introduce branching points, with the molar ratio adjusted accordingly. It will be understood that the polyester may be a co-polyester, comprising a mixture of polyol monomers and/or a mixture of polyacid monomers with different structures and/or chain lengths.

The one or more polyesters may contain tricyclodecane derived polyols, as described in U.S. Pat. No. 8,758,862 B2 (incorporated herein by reference in its entirety) commercial examples of which include TEGOR AddBond LTH, LTW, and LTS, available from Evonik Tego Chemic GmbH.

The one or more polyesters may contain a dicarboxylic acid constituent and a glycol constituent, for example a dicarboxylic acid constituent comprising a mixture of terephthalic acid and isophthalic acid in a mass ratio of, for example, about 60:40 and a glycol constituent comprising ethylene glycol and neopentyl glycol in a mass ratio of, for example, about 15:85, as described in U.S. Pat. No. 5,025,061 B2, incorporated herein by reference. Examples of such resins include Vylon resins, such as Vylon 240 and Vylon 660, available from Toyobo.

In embodiments, a single polyester may be used. Alternatively, a mixture of polyesters may be used. In embodiments wherein the one or more binder resins comprise one or more polyester, the polyesters may be present in an amount of from about 2% to about 25% by weight of the ink composition, preferably in an amount of from about 5% to about 20% by weight of the ink composition, more preferably in an amount of from about 10% to about 15% by weight of the ink composition. The one or more polyesters may have an Mn from about 2000 g/mol to about 30000 g/mol, preferably from about 3000 g/mol to about 8000 g/mol. Alternatively, the one or more polyesters may have an Mn of about 15000 g/mol.

In embodiments, the one or more binder resins comprises a copolymer of vinyl chloride and vinyl acetate, and a polyester. In such embodiments, the one or more binder resins may be present in an amount of from about 2% to about 20% by weight of the ink composition, preferably in an amount of from about 5% to about 15% by weight of the ink composition, more preferably in an amount of from about 8% to about 12% by weight of the ink composition. More specifically, the binder resins may be present in the following amounts: the copolymer of vinyl chloride and vinyl acetate in an amount of from about 0.5% to about 5% by weight of the ink composition and the polyester in an amount of from about 2% to about 15% by weight of the ink composition, preferably the copolymer of vinyl chloride and vinyl acetate in an amount of from about 1% to about 4% by weight of the ink composition and the polyester in an amount of from about 5% to about 12% by weight of the ink composition, more preferably the copolymer of vinyl chloride and vinyl acetate in an amount of from about 1.5% to about 3.5% by weight of the ink composition and the polyester in an amount of from about 6% to about 10% by weight of the ink composition.

In any of the inventive embodiments, the ink composition contains at least one colorant. The colorant can be present in an amount from about 0.1% to about 12%, preferably from about 1% to about 10%, and more preferably from about 2% to about 8% by weight of the inkjet ink composition.

The colorant can be any colorant or combination of colorants suitable for the printing use. The colorant preferably is a dye. In an embodiment of the invention, one or more dyes are employed as the colorant, which dyes are selected from the group consisting of acid dyes, basic dyes, solvent dyes, disperse dyes, mordant dyes and any combination thereof. Examples of solvent dyes include naphthol dyes, azo dyes, metal complex dyes, anthraquinone dyes, quinoimine dyes, indigoid dyes, benzoquinone dyes, carbonium dyes, naphthoquinone dyes, naphthalimide dyes, phthalocyanine dyes, and perylene dyes.

For example, the ink composition according to certain embodiments of the invention can include one or more dyes selected from the group consisting of C.I. Solvent Black 3, C.I. Solvent Black 5, C.I. Solvent Black 7, C.I. Solvent Black 22, Solvent Black 26, C.I. Solvent Black 27 (such as VALIFAST BLACK® 3840L, VALIFAST BLACK® 3820), C.I. Solvent Black 29 (such as VALIFAST BLACK® 3808, ORASOL BLACK X55™, and DL BLACK N36B™), C.I. Solvent Black 48, any combination thereof. Preferred solvent dyes are Solvent Black 27 (VALIFAST BLACK® 3840L, VALIFAST BLACK® 3820), Solvent Black 29 (ORASOL BLACK X55™), Solvent Black 29 (VALIFAST BLACK® 3808) and Solvent Black 29 (DL BLACK N36B™). A most preferred solvent dye is Solvent Black 27 (VALIFAST BLACK® 3840L, VALIFAST BLACK® 3820).

The ink composition of the invention may further include one or more additives such as plasticizers, surfactants, defoamers, adhesion promoters, and mixtures thereof. The additive preferably is miscible with the ink composition and does not phase separate from the composition during application of the ink to a substrate during printing.

Examples of surfactants which can be used include fluorosurfactants, siloxanes, silicones, silanols, polyoxyalkyleneamines, propoxylated (poly(oxypropylene)) diamines, alkyl ether amines, nonyl phenol ethoxylates, ethoxylated fatty amines, quaternized copolymers of vinylpyrrolidone and dimethyl aminoethyl methacrylate, fluorinated organic acid diethanolamine salts, alkoxylated ethylenediamines, polyethylene oxides, polyoxyalkylene polyalkylene polyamines amines, polyoxyalkylene polyalkylene polyimines, alkyl phosphate ethoxylate mixtures, polyoxyalkylene derivatives of propylene glycol, and polyoxyethylated fatty alcohols, or any combination thereof. A preferred specific example of a suitable polymeric surfactant is DOWSIL™ 205SL Additive, available from The Dow Chemical Company, which is a silicone surfactant. The surfactant additive can be present in an amount from about 0.01 to about 1.0%, or preferably from about 0.02 to about 0.5%, by weight of the inkjet ink composition.

The ink composition also can include an adhesion promoter. A suitable adhesion promoter is a silane, such as SILQUEST® WETLINK 78, which is glycidoxypropyl diethoxymethylsilane, SILQUEST® A-186 SILANE, which is beta-(3,4-epoxycyclohexyl)ethyltrimethoxy silane, and SILQUEST® A-187 SILANE, which is gamma-glycidoxypropyltrimethoxy silane, all available from Momentive Performance Materials. The adhesion promoter can be present in an amount from about 0.1 to about 2%, preferably from about 0.2 to about 1.0%, and more preferably about 0.5% by weight of the ink composition.

The ink composition preferably includes little or no water. Water is preferably present in an amount less than 5%, more preferably less than 4%, even more preferably less than 2%, and most preferably less than 1% by weight of the inkjet ink composition.

The ink composition of the invention can be prepared by any suitable method. For example, the chosen ingredients may be combined and mixed with adequate stirring and the resulting fluid filtered to remove any undissolved impurities.

The present invention further provides a method for printing images on a substrate in a continuous inkjet printer comprising directing a stream of droplets of any of the embodiments of the ink composition of the invention described herein to a substrate and allowing the ink droplets to dry, thereby printing images on a substrate. Any continuous inkjet printing methods and equipment as known in the art are contemplated for use with the invention. Any suitable substrate may be printed in accordance with the invention. Examples of suitable substrates include porous substrates such as uncoated paper and cardboard and the like; semi-porous substrates such as aqueous coated paper, clay coated paper, silica coated paper, UV overcoated paper, polymer overcoated paper, and varnish overcoated paper and the like; and non-porous substrates such as plastics (e.g., high density polyethylene, low density polyethylene), polymer films, and the like, metals and alloys (e.g., steel, aluminum, brass, and the like); glass, and ceramics. The paper substrates may be thin sheets of paper, rolls of paper, or cardboard. Plastics, metals, glass, and ceramic substrates may be in any suitable form such as in the form of bottles or containers, plates, rods, cylinders, etc. The paper substrates may be articles made of paper or cardboard, including thin sheets of paper, rolls of paper, or cardboard sheets. In certain embodiments, the printing operation can be performed in industries such as the electronics, cosmetic, healthcare, and pharmaceutical industries, where the printing of solvent resistant marks on non-porous substrates may be required.

Because of the natural variation in viscosity in ink compositions made according to the same or similar formulas, during manufacture of the ink the product is intentionally made slightly more concentrated or with slightly higher viscosity (more solids) than needed. It then can be diluted as necessary with more or less additional solvent to meet a particular viscosity range requirement.

### Specific Ink Formulations

The following formulations have been found to be particularly efficacious in providing inks that form markings with resistance to solvents.

In some embodiments, the ink comprises methyl propyl ketone, ethanol, a copolymer of vinyl chloride and vinyl acetate, and a solvent dye. In a preferred embodiment, the methyl propyl ketone is present in an amount of from about 65% to 75% by weight of the ink composition, the ethanol is present in an amount of from about 10% to about 20% by weight of the ink composition, the copolymer of vinyl chloride and vinyl acetate is present in an amount from about 5% to about 15% by weight of the ink composition, and the solvent dye is present in an amount from about 3 to about 10% by weight of the ink composition. In a particular embodiment, the methyl propyl ketone is present in an amount of about 70% by weight of the ink composition, the ethanol is present in an amount of about 15% by weight of the ink composition, the copolymer of vinyl chloride and vinyl acetate is present in an amount of about 9% by weight of the ink composition, and the solvent dye is present in an amount of about 6% by weight of the ink composition.

In some embodiments, the ink comprises methyl propyl ketone, ethanol, ethyl acetate, a copolymer of vinyl chloride and vinyl acetate, and a solvent dye. In a preferred embodiment, the methyl propyl ketone is present in an amount of from about 30% to 50% by weight of the ink composition, the ethanol is present in an amount of from about 2% to about 15% by weight of the ink composition, the ethyl acetate is present in an amount of from about 25% to about 50% by weight of the ink composition, the copolymer of vinyl chloride and vinyl acetate is present in an amount from about 5% to about 15% by weight of the ink composition, and the solvent dye is present in an amount from about 3 to about 10% by weight of the ink composition. In a particular embodiment, the methyl propyl ketone is present in an amount of about 40% by weight of the ink composition, the ethanol is present in an amount from about 4% to about 13% by weight of the ink composition, the ethyl acetate is present in an amount from about 30% to about 40 by weight of the ink composition, the copolymer of vinyl chloride and vinyl acetate is present in an amount of about 8% by weight of the ink composition, and the solvent dye is present in an amount from about 6% to about 7% by weight of the ink composition.

In some embodiments, the ink comprises methyl propyl ketone, ethanol, cyclopentanone or cyclohexanone, a copolymer of vinyl chloride and vinyl acetate, and a solvent dye. In a preferred embodiment, the methyl propyl ketone is present in an amount of from about 65% to 75% by weight of the ink composition, the ethanol is present in an amount of from about 10% to about 20% by weight of the ink composition, the cyclopentanone or cyclohexanone is present in an amount of from about 1% to about 10% by weight of the ink composition, the copolymer of vinyl chloride and vinyl acetate is present in an amount from about 5% to about 15% by weight of the ink composition, and the solvent dye is present in an amount from about 3 to about 10% by weight of the ink composition. In a particular embodiment, the methyl propyl ketone is present in an amount of about 70% by weight of the ink composition, the ethanol is present in an amount of about 15% by weight of the ink composition, the cyclopentanone or cyclohexanone is present in an amount of about 5% by weight of the ink composition, the copolymer of vinyl chloride and vinyl acetate is present in an amount of about 9% by weight of the ink composition, and the solvent dye is present in an amount of about 6% by weight of the ink composition.

In some embodiments, the ink comprises methyl propyl ketone, cyclopentanone or cyclohexanone, a copolymer of vinyl chloride and vinyl acetate, and a solvent dye. In a preferred embodiment, the methyl propyl ketone is present in an amount of from about 65% to 85% by weight of the ink composition, the cyclopentanone or cyclohexanone is present in an amount of from about 1% to about 10% by weight of the ink composition, the copolymer of vinyl chloride and vinyl acetate is present in an amount from about 5% to about 15% by weight of the ink composition, and the solvent dye is present in an amount from about 3 to about 10% by weight of the ink composition. In a particular embodiment, the methyl propyl ketone is present in an amount of about 80% by weight of the ink composition, the cyclopentanone or cyclohexanone is present in an amount of about 5% by weight of the ink composition, the copolymer of vinyl chloride and vinyl acetate is present in an amount of about 9% by weight of the ink composition, and the solvent dye is present in an amount of about 6% by weight of the ink composition.

In some embodiments, the ink comprises methyl propyl ketone, cyclopentanone or cyclohexanone, a copolymer of vinyl chloride and vinyl acetate, a polyester and a solvent dye. In a preferred embodiment, the methyl propyl ketone is present in an amount of from about 65% to 85% by weight of the ink composition, the cyclopentanone or cyclohexanone is present in an amount of from about 1% to about 10% by weight of the ink composition, the copolymer of vinyl chloride and vinyl acetate is present in an amount from about 1% to about 5% by weight of the ink composition, the polyester is present in an amount from about 5% to about 15% by weight of the ink composition, and the solvent dye is present in an amount from about 3 to about 10% by weight of the ink composition. In a particular embodiment, the methyl propyl ketone is present in an amount of about 75% by weight of the ink composition, the cyclopentanone or cyclohexanone is present in an amount of about 8% by weight of the ink composition, the copolymer of vinyl chloride and vinyl acetate is present in an amount of about 2% by weight of the ink composition, the polyester is present in an amount of about 7% by weight of the ink composition, and the solvent dye is present in an amount of about 6% by weight of the ink composition.

In some embodiments, the ink comprises methyl propyl ketone, cyclopentanone or cyclohexanone, a polyester and a solvent dye. In a preferred embodiment, the methyl propyl ketone is present in an amount of from about 65% to 85% by weight of the ink composition, the cyclopentanone or cyclohexanone is present in an amount of from about 1% to about 10% by weight of the ink composition, the polyester is present in an amount from about 5% to about 15% by weight of the ink composition, and the solvent dye is present in an amount from about 3 to about 10% by weight of the ink composition. In a particular embodiment, the methyl propyl ketone is present in an amount of about 75% by weight of the ink composition, the cyclopentanone or cyclohexanone is present in an amount of about 8% by weight of the ink composition, the polyester is present in an amount of about 10% by weight of the ink composition, and the solvent dye is present in an amount of about 6% by weight of the ink composition.

### Examples

It is to be understood that this invention is not limited to the particular exemplified processes, compositions, or methodologies described, as these may vary. It is also to be understood that the terminology used in the description is for the purpose of describing the particular versions or embodiments only, and is not intended to limit the scope of the present invention which will be limited only by the appended claims. Unless defined, otherwise, all technical and scientific terms used herein have the same meanings as commonly understood by one of ordinary skill in the art. Although any methods and materials similar or equivalent to those described herein can be used in the practice or testing of embodiments of the present invention, certain specific and preferred embodiments are now described. All publications mentioned herein, are incorporated by reference in their entirety. Nothing herein is to be construed as an admission that the invention is not entitled to antedate such disclosure by virtue of prior invention.

Vinnol E 15-45M TF is a copolymer of vinyl chloride and vinyl acetate available from Wacker Chemie AG containing approximately 84% by weight vinyl chloride, 15% by weight vinyl acetate, and 1% by weight dicarboxylic acid and having a K-value of 44-46 (determined using ISO 1628-2:2020) and Mw of 50000 to 60000 g/mol (determined using SEC with PS-standards).

Vinnol H 14/36 TF is a copolymer of vinyl chloride and vinyl acetate available from Wacker Chemie AG containing approximately 86% by weight vinyl chloride and 14% by weight vinyl acetate, and having a K-value of 34-36 (determined using ISO 1628-2:2020) and Mw of 30000 to 40000 g/mol (determined using SEC with PS-standards).

Solbin CLL is a copolymer of vinyl chloride and vinyl acetate available from Shin-Etsu Chemical Co. Ltd containing approximately 84% by weight vinyl chloride and 16% by weight vinyl acetate, and having a Mn of about 15000 g/mol to about 25000 g/mol and a Mw of about 30000 g/mol to about 40000 g/mol (determined using SEC with PS-standards and a THF eluent).

Addbond LTH is a polyester available from Evonik Tego Chemie GmbH containing tricyclodecane-based polyols with Mn of about 3000 g/mol and Mw about 6000 g/mol (determined using SEC with PS-standards and a THF eluent).

Vylon 660 is a copolyester available from TOYOBO Co., Ltd. composed of a polyol component of ethylene glycol and neopentyl glycol in a mass ratio of about 15:85 and a polyacid component of terephthalic acid and isophthalic acid in a mass ratio of about 60:40 with Mn of about 8000 g/mol.

Vylon 240 is a copolyester available from TOYOBO Co., Ltd. composed of a polyol component of ethylene glycol and neopentyl glycol in a mass ratio of about 15:85 and a polyacid component of terephthalic acid and isophthalic acid in a mass ratio of about 60:40 with Mn of about 15000 g/mol.

### Example 1: Solvent Resistant Ink Compositions Comprising Copolymers of Vinyl Chloride and Vinyl Acetate

Ink compositions 1, 2, 3, 4, 5, 6, 7, and 8 were produced with the components indicated below by combining and mixing the components until all solid ingredients were dissolved. The viscosity and resistivity of the inks was then measured to ensure that they are suitable for CIJ inks.

| Ink | | | | | | | | |
|---|---|---|---|---|---|---|---|---|
| Composition | Ink 1 | Ink 2 | Ink 3 | Ink 4 | Ink 5 | Ink 6 | Ink 7 | Ink 8 |
| Methyl | 69.70 | 70.5 | 75.25 | 69.3 | 38 | 39.2 | 73.2 | 69.7 |
| Propyl | | | | | | | | |
| Ketone | | | | | | | | |
| Ethanol | 15.33 | 15.5 | 10 | | 4.2 | 12.8 | | 15.33 |
| SDA 3C 200 | | | | | | | | |
| Proof | | | | | | | | |
| n-propanol | | | | | | | 10 | |
| isopropyl | | | | 15.33 | | | | |
| acetate | | | | | | | | |
| Vinnol E 15- | 1.60 | 1.6 | 1.6 | 1.5 | 1.5 | 1.5 | 1.7 | 1.6 |
| 45M TF | | | | | | | | |
| Vinnol H | 7.00 | | 2 | 6.5 | 6.5 | 6.5 | 6.8 | 7 |
| 14/36 TF | | | | | | | | |
| Solbin CLL | | 6 | 5 | | | | | |
| ethyl acetate | | | | | 41 | 32.5 | | |
| Distilled | | | | | 1.8 | 1 | | |
| water | | | | | | | | |
| BYK-65 | | | | | | | | 0.9 |
| Silwet L- | | | | | | | | 0.03 |
| 7622 | | | | | | | | |
| Silquest | 0.50 | 0.5 | 0.8 | 0.5 | | | | |
| WetLink 78 | | | | | | | | |
| Silane | | | | | | | | |
| PDMS100 | 0.01 | 0.01 | 0.05 | 0.01 | | | 0.1 | |
| Dowsil | 0.06 | 0.06 | | 0.06 | | | | |
| 205SL | | | | | | | | |
| Additive | | | | | | | | |
| Duasyn | | | | | | | | 5.8 |
| Black ARG | | | | | | | | |
| VP-280 | | | | | | | | |
| Valifast | 5.80 | 5.80 | 5.3 | 6.80 | 7.00 | 6.50 | | |
| Black 3820 | | | | | | | | |
| Valifast | | | | | | | 8.2 | |
| 3840 (SB27) | | | | | | | | |
| Total | 100.00 | 99.97 | 100.00 | 100.00 | 100.00 | 100.00 | 100.00 | 100.36 |
| Viscosity | 4.19 | 4.37 | 4.41 | 3.98 | 4.33 | 4.18 | 4.75 | 4.23 |
| (cP) | | | | | | | | |
| Resistivity | 1287 | 1193 | 1358 | 1420 | 1228 | 1305 | 1320 | 1363 |
| (ohm-cm) | | | | | | | | |

### Example 2: Solvent Resistant Ink Compositions Comprising Polyesters

Ink compositions 9, 10, 11, and 12 were produced with the components indicated below by combining and mixing the components until all solid ingredients were dissolved. The viscosity and resistivity of the inks was then measured to ensure that they are suitable for CIJ inks.

| | Ink 9 | Ink 10 | Ink 11 | Ink 12 |
|---|---|---|---|---|
| Methyl Propyl Ketone | 71.95 | 62.3 | 67.6 | 71.2 |
| Ethanol SDA 3C 200 Proof | | 14 | | |
| n-propanol | 10.00 | | | |
| isopropyl acetate | | | 11.97 | 12.53 |
| Vinnol E 15-45M TF | 3.50 | | | 2 |
| Solbin CLL | | | 3 | |
| BYK-65 | | | 0.9 | |
| Silwet L-7622 | | | 0.03 | |
| Vylon 660 | | | 9 | |
| Vylon 240 | | | | 7 |
| Add Bond LTH | 7.50 | 14 | | |
| CAP 482-0.5 | | 1.1 | | |
| PDMS100 | 0.05 | | | 0.01 |
| Dowsil 205SL Additive | | | | 0.06 |
| Duasyn Black ARG VP-280 | | | 7.50 | |
| Valifast Black 3820 | 7.00 | 8.50 | | 7.20 |
| Total | 100.00 | 99.90 | 100.00 | 100.00 |
| Viscosity (cP) | 3.98 | 3.87 | 4.08 | 3.92 |
| Resistivity (ohm-cm) | 1400 | 1276 | 1649 | 1345 |

### Example 3: Solvent Resistant Ink Compositions Comprising Additional Solvents

Additional solvents were added to Ink 8 to explore their effect on the solvent resistance of the ink. Marks were printed with a Videojet 1620® CIJ printer equipped with a 60 micron nozzle on plain glass microscope slides obtained from Fisher Scientific. The printed slides were allowed to sit at ambient condition for 24 hours before soak into ethanol solvent for 10 minutes. The printed code was then visually evaluated based on the following grading criteria:
1—fade>50% with less than 5 minutes soaking;
2—fade>50% after 10 minutes soaking;
3—fade of 10 to 50% after 10 minutes soaking
4—fade of 0 to 10% after 10 minutes soaking

| | Ethanol soaking Resistance on |
|---|---|
| | Glass substrates |
| Example 8 | 2 |
| Example 8 + 5% Butyl lactate | 1 |
| Example 8 + 5% Ethyl lactate | 1 |
| Example 8 + 5% cyclohexanone | 3 |
| Example 8 + 5% cyclopentanone | 3 |
| Example 8 + 5% amyl acetate | 2 |
| Example 8 + 5% diacetone ketone | 1 |
| Example 8 + 5% 2-hydroxylethyl | 1 |
| pyrrolidone | |
| Example 8 + 5% methyl isobutyl | 2 |
| ketone | |

### Example 4: Solvent Resistant Ink Compositions Comprising Cyclic Ketones

Ink compositions 13, 14, 15, 16, 17, 18, and 19 were produced with the components indicated below by combining and mixing the components until all solid ingredients were dissolved.

| Ink | | | | | | | |
|---|---|---|---|---|---|---|---|
| Composition | Ink 13 | Ink 14 | Ink 15 | Ink 16 | Ink 17 | Ink 18 | Ink 19 |
| Methyl Propyl | 79.00 | 66 | 74.7 | 74.3 | 73.6 | 75 | 65.93 |
| Ketone | | | | | | | |
| Ethanol SDA | | 14.53 | | | | | |
| 3C 200 Proof | | | | | | | |
| isopropyl | | | | | | | 6 |
| acetate | | | | | | | |
| Vinnol E 15- | 1.93 | 1.6 | 0.5 | 0.5 | | 1.7 | |
| 45M TF | | | | | | | |
| Vinnol H 14/36 | 7.40 | 6.8 | | | | | |
| TF | | | | | | | |
| Solbin CLL | | | 1.5 | 1.5 | | | 1.5 |
| Cyclohexanone | 4.77 | | | | | | |
| Cyclopentanone | | 5 | 8.34 | 8.24 | 8.33 | 8.57 | 8 |
| BYK-65 | 0.86 | | | | | 0.9 | |
| Silwet L-7622 | 0.03 | | | | | 0.03 | |
| Vylon 660 | | | | 8 | | | 10 |
| GK-240 | | | 7.5 | | 10 | 6.8 | |
| PDMS100 | | 0.01 | 0.01 | 0.01 | 0.01 | | 0.01 |
| Dowsil 205SL | | 0.06 | 0.06 | 0.06 | 0.06 | | 0.06 |
| Additive | | | | | | | |
| Valifast Black | 6.01 | 6.00 | 7.30 | 7.30 | 7.00 | 7.00 | |
| 3820 | | | | | | | |
| Duasyn Black | | | | | | | 8.5 |
| ARG VP-280 | | | | | | | |
| Total | 100.00 | 100.00 | 99.91 | 99.91 | 99.00 | 100.00 | 100.00 |

Marks were printed using these inks with a Videojet 1620® CIJ printer equipped with a 60 micron nozzle on a variety of surfaces. The printed slides were allowed to sit at ambient condition for 24 hours before soak into ethanol solvent for 10 minutes. The printed code was then visually evaluated based on the following grading criteria:
1—fade>50% with less than 5 minutes soaking;
2—fade>50% after 10 minutes soaking;
3—fade of 10 to 50% after 10 minutes soaking
4—fade of 0 to 10% after 10 minutes soaking

| | Glass | Aluminum | HDPE | Nylon |
|---|---|---|---|---|
| Ink 13 | 3 | 4 | 4 | 4 |
| Ink 14 | 3 | 4 | 4 | 4 |
| Ink 15 | 4 | 4 | 4 | 4 |
| Ink 16 | 4 | 4 | 2 | 4 |
| Ink 17 | 4 | 4 | 4 | 4 |
| Ink 18 | 4 | 4 | 4 | 4 |
| Ink 19 | 4 | 4 | 4 | 4 |

### Example 5: Comparison of Solvent Resistance Against Alternative Inks

The following comparative inks utilise different combinations of solvents and binder resins than the inks of the present invention. In many ways, these comparative inks have excellent performance as continuous inkjet inks, exhibiting fast drying times and strong adhesion to a range of surfaces. However, as shown below, they are not as resistant to solvents, such as ethanol and iso-propanol, as the inks of the present invention.

| | Comparative | Comparative | Comparative |
|---|---|---|---|
| | Ink 1 | Ink 2 | Ink 3 |
| Methyl Propyl Ketone | | 64.18 | 61.39 |
| Methyl Isopropyl Ketone | 79.60 | | |
| Ethanol SDA 3C 200 Proof | | 14 | 14 |
| CAB 551-0.1 | | | 6.3 |
| DOWSIL RSN-0233 | | | 2.9 |
| K-Plast 1022 | | | 5.1 |
| BYK-65 | 0.90 | | |
| Silwet L-7622 | 0.50 | | |
| Staybellite ester 10 | 6.00 | 7 | |
| Polyvinyl Butyral S-LEC | 3.50 | 3.50 | |
| BL-10 | | | |
| CAP 482-0.5 | 1.00 | 1.00 | |
| PDMS100 | | 0.02 | 0.01 |
| Dowsil 205SL Additive | | 0.90 | 0.10 |
| Distilled water | | 1.00 | |
| P8 plasticizer | | 0.90 | |
| Silane A-187 | | | 1.20 |
| Valifast Black 3878 | 8.50 | | |
| Valifast Black 3840 | | 7.50 | |
| Valifast Black 3820 | | | 9.00 |
| Total | 100.00 | 100.00 | 100.00 |
| Viscosity (cP) | 3.82 | 4.08 | 4.18 |
| Resistivity (ohm-cm) | 1332 | 1353 | 1182 |

Marks were printed using these inks with a Videojet 1620® CIJ printer equipped with a 60 micron nozzle on a variety of surfaces. The printed slides were allowed to sit at ambient condition for 24 hours before soak into ethanol solvent for 10 minutes. The printed code was then visually evaluated based on the following grading criteria:
1—fade>50% with less than 5 minutes soaking;
2—fade>50% after 10 minutes soaking;
3—fade of 10 to 50% after 10 minutes soaking
4—fade of 0 to 10% after 10 minutes soaking

| Ink | Glass | Aluminum | HDPE | Nylon |
|---|---|---|---|---|
| Ink 1 | 3 | 4 | 4 | 4 |
| Comparative Ink 1 | 1 | 1 | 1 | 1 |
| Comparative Ink 2 | 1 | 1 | 1 | 1 |
| Comparative Ink 3 | 1 | 1 | 1 | 1 |

Marks were printed using these inks with a Videojet 1620® CIJ printer equipped with a 60 micron nozzle on a variety of surfaces. The printed slides were allowed to sit at ambient condition for 24 hours before soak into iso-propanol solvent for 10 minutes. The printed code was then visually evaluated based on the following grading criteria:
1—fade>50% with less than 5 minutes soaking;
2—fade>50% after 10 minutes soaking;
3—fade of 10 to 50% after 10 minutes soaking
4—fade of 0 to 10% after 10 minutes soaking

| Ink | Glass | Aluminum | HDPE | Nylon |
|---|---|---|---|---|
| Ink 1 | 4 | 4 | 4 | 4 |
| Comparative Ink 1 | 1 | 1 | 1 | 1 |
| Comparative Ink 2 | 1 | 1 | 1 | 1 |
| Comparative Ink 3 | 1 | 1 | 1 | 1 |

### CLAUSES OF THE INVENTION

Clause 1. An ink composition comprising:
(a) a solvent comprising one or more volatile C₅ ketones, the one or more volatile C₅ ketones present in an amount from about 30% to about 80% by weight of the ink composition,
(b) a cosolvent selected from ethanol, n-propanol, isopropanol, isopropyl acetate, n-propyl acetate, ethyl acetate, cyclopentanone, cyclohexanone and mixtures thereof, the cosolvent present in an amount from about 3% to about 45% by weight of the ink composition;
(c) one or more binder resins selected from copolymers of vinyl chloride and vinyl acetate, polyesters, co-polyesters, and mixtures thereof, the total binder resin present in an amount from about 2% to about 20% by weight of the ink composition; and
(d) one or more colorants.

Clause 2. The ink composition of clause 1, wherein the one or more volatile C₅ ketones is selected from the group consisting of 2-pentanone (methyl propyl ketone), 3-pentanone (diethyl ketone), 3-methyl-2-butanone (methyl isopropyl ketone), and mixtures thereof.

Clause 3. The ink composition of clause 1 or clause 2, wherein the one or more volatile C5 ketone solvent is methyl propyl ketone.

Clause 4. The ink composition of any one of clauses 1 to 3, wherein the cosolvent is selected from ethanol, cyclopentanone, cyclohexanone, a mixture of ethanol and ethyl acetate, a mixture of ethanol and cyclopentanone, a mixture of ethanol and cyclohexanone, and a mixture of isopropyl acetate and cyclohexanone.

Clause 5. The ink composition of any one of clauses 1 to 4, wherein the one or more volatile ketones is present in an amount from about 65% to about 80% by weight of the ink composition.

Cause 6. The ink composition of any one of clauses 1 to 5, wherein the cosolvent is present in an amount from about 5% to about 20% by weight of the ink composition, optionally from about 10% to about 18% by weight of the ink composition.

Clause 7. The ink composition of any one of clauses 1 to 6, wherein the one or more binder resins are copolymers of vinyl chloride and vinyl acetate.

Clause 8. The ink composition of any one of clauses 1 to 6, wherein the one or more binder resins are a mixture of copolymers of vinyl chloride and vinyl acetate and polyester.

Clause 9. The ink composition of any one of clauses 1 to 8, wherein the one or more binder resins are present in an amount from about 7% to about 16% by weight of the ink composition.

Clause 10. The ink composition of any one of clauses 1 to 9, wherein the one or more colorants are selected from the group consisting of Solvent Black 29, Solvent Black 27, and mixtures thereof.

Clause 11. The ink composition of any one of clauses 1 to 10, which further comprises one or more additives selected from the group consisting of one or more surfactants, one or more plasticizers, one or more adhesion promoters, one or more conductive agents, one or more corrosion inhibitors, one or more defoamers, and mixtures thereof.

Clause 12. The ink composition of clause 11, wherein the surfactant is present in an amount from about 0.1% to about 2.0% by weight of the ink composition.

Clause 13. The ink composition of clause 11 or clause 12, wherein the one or more surfactants are polyalkyleneoxide modified polysiloxanes.

Clause 14. The ink composition of any one of clauses 11 to 13, wherein the corrosion inhibitor is present in an amount between 0.01% and 0.2% by weight of the ink composition.

Clause 15. The ink composition of any one of clauses 1 to 7 and 9 to 14, wherein the one or more volatile C5 ketone solvent is methyl propyl ketone, the cosolvent is ethanol, and the one or more binder resins are copolymers of vinyl chloride and vinyl acetate.

Clause 16. The ink composition of clause 15, wherein the methyl propyl ketone is present in an amount of about 70% by weight of the ink composition, the ethanol is present in an amount of about 15% by weight of the ink composition, and the copolymers of vinyl chloride and vinyl acetate are present in an amount of about 9% by weight of the ink composition.

Clause 17. A method of continuous inkjet printing on a substrate comprising: directing a stream of droplets of an ink composition of any one of clauses 1 to 16 onto the substrate and allowing the droplets to dry, to print an image on the substrate.

Clause 18. The method of clause 17, wherein the substrate is selected from the group consisting of uncoated paper, coated paper, hard or soft plastics, polymer films, metals and alloys, glass, and ceramics.

What is claimed is:

1. An ink composition comprising:
(a) a solvent comprising one or more volatile C₅ ketones, the one or more volatile C₅ ketones present in an amount from about 30% to about 80% by weight of the ink composition,
(b) a cosolvent selected from ethanol, n-propanol, isopropanol, isopropyl acetate, n-propyl acetate, ethyl acetate, cyclopentanone, cyclohexanone and mixtures thereof, the cosolvent present in an amount from about 3% to about 45% by weight of the ink composition;
(c) one or more binder resins selected from copolymers of vinyl chloride and vinyl acetate, polyesters, co-polyesters, and mixtures thereof, the total binder resin present in an amount from about 2% to about 20% by weight of the ink composition; and
(d) one or more colorants.

2. The ink composition of claim 1, wherein the one or more volatile C₅ ketones is selected from the group consisting of 2-pentanone (methyl propyl ketone), 3-pentanone (diethyl ketone), 3-methyl-2-butanone (methyl isopropyl ketone), and mixtures thereof.

3. The ink composition of claim 1, wherein the one or more volatile C5 ketone solvent is methyl propyl ketone.

4. The ink composition of claim 1, wherein the cosolvent is selected from ethanol, cyclopentanone, cyclohexanone, a mixture of ethanol and ethyl acetate, a mixture of ethanol and cyclopentanone, a mixture of ethanol and cyclohexanone, and a mixture of isopropyl acetate and cyclohexanone.

5. The ink composition of claim 1, wherein the one or more volatile ketones is present in an amount from about 65% to about 80% by weight of the ink composition.

6. The ink composition of claim 1, wherein the cosolvent is present in an amount from about 5% to about 20% by weight of the ink composition, optionally from about 10% to about 18% by weight of the ink composition.

7. The ink composition of claim 1, wherein the one or more binder resins are copolymers of vinyl chloride and vinyl acetate.

8. The ink composition of claim 1, wherein the one or more binder resins are a mixture of copolymers of vinyl chloride and vinyl acetate and polyester.

9. The ink composition of claim 1, wherein the one or more binder resins are present in an amount from about 7% to about 16% by weight of the ink composition.

10. The ink composition of claim 1, wherein the one or more colorants are selected from the group consisting of Solvent Black 29, Solvent Black 27, and mixtures thereof.

11. The ink composition of claim 1, which further comprises one or more additives selected from the group consisting of one or more surfactants, one or more plasticizers, one or more adhesion promoters, one or more conductive agents, one or more corrosion inhibitors, one or more defoamers, and mixtures thereof.

12. The ink composition of claim 11, wherein the surfactant is present in an amount from about 0.1% to about 2.0% by weight of the ink composition.

13. The ink composition of claim 11, wherein the one or more surfactants are polyalkyleneoxide modified polysiloxanes.

14. The ink composition of claim 11, wherein the corrosion inhibitor is present in an amount between 0.01% and 0.2% by weight of the ink composition.

15. The ink composition of claim 1, wherein the one or more volatile C5 ketone solvent is methyl propyl ketone, the cosolvent is ethanol, and the one or more binder resins are copolymers of vinyl chloride and vinyl acetate.

16. The ink composition of claim 15, wherein the methyl propyl ketone is present in an amount of about 70% by weight of the ink composition, the ethanol is present in an amount of about 15% by weight of the ink composition, and the copolymers of vinyl chloride and vinyl acetate are present in an amount of about 9% by weight of the ink composition.

17. A method of continuous inkjet printing on a substrate comprising: directing a stream of droplets of an ink composition of claim 1 onto the substrate and allowing the droplets to dry, to print an image on the substrate.

18. The method of claim 17, wherein the substrate is selected from the group consisting of uncoated paper, coated paper, hard or soft plastics, polymer films, metals and alloys, glass, and ceramics.
